(19) United States
(12) Patent Application Publication
(10) Pub. No.: US 2026/0229894 A1
(43) Pub. Date: Aug. 6, 2026

(54) ELECTRIC VEHICLE SUPPLY EQUIPMENT EXPORT FUNCTION INHIBITION

(71) Applicant: FORD GLOBAL TECHNOLOGIES, LLC, Dearborn, MI (US)

(72) Inventors: Richard Mo, Canton, MI (US); Timothy Harris, Grosse Ile, MI (US); Christopher Bernard Trombetta, Commerce Township, MI (US)

(21) Appl. No.: 19/046,815

(22) Filed: Feb. 6, 2025

(51) Int. Cl. H02J 3/32; B60L 53/16; B60L 53/30; B60L 55/00

(52) U.S. Cl. CPC H02J 3/322; B60L 53/16; B60L 53/30; B60L 55/00

(57) ABSTRACT

Electric vehicle supply equipment (EVSE) includes an enclosure with internal circuitry comprising ground and power line assemblies terminating in busbars, a power cord with a vehicle coupler, and a ground monitoring impedance circuit. The circuitry is designed to de-energize the system automatically if the enclosure is removed from a building’s mounting pan while the busbars are energized. The ground monitoring impedance circuit detects faults and triggers switches to open when impedance thresholds are exceeded. Additionally, the EVSE supports bidirectional energy flow between the vehicle and the power grid.

### TECHNICAL FIELD

This disclosure relates generally to electric vehicles, and more particularly to electric vehicle supply equipment.

### BACKGROUND

Electric vehicle supply equipment (EVSE) may provide the hardware and software necessary to transfer electrical energy from a building to a vehicle, or from a vehicle to a building. An EVSE may be mounted to a building and be in electrical connection with an electric utility grid.

### SUMMARY

An electric vehicle supply equipment (EVSE) is designed with an enclosure containing circuitry that includes ground and power line assemblies, each terminating in busbars. These assemblies are configured to de-energize automatically if the EVSE enclosure is removed from a building’s mounting pan while energized by a connected vehicle. The system incorporates a ground monitoring impedance circuit that monitors the ground line assembly and can trigger the opening of switches (relays) within the power line assemblies. Additionally, the circuitry supports bidirectional energy flow between the vehicle and the building, and it can detect faults based on specific impedance thresholds in the ground line assembly.

An EVSE includes a power cord with a coupler for connecting to a vehicle, an enclosure housing circuitry, and multiple busbars that interface with a power grid’s power and ground lines. The circuitry incorporates switches between the power cord and busbars, and a ground monitoring impedance circuit that opens the switches if the ground line’s impedance exceeds a set threshold. Additionally, the system is designed to exceed the impedance threshold if the enclosure is removed from a building’s mounting pan while busbars are energized. The circuitry also supports bidirectional energy flow between the vehicle and the power grid and can detect and signal faults when the ground line impedance falls within a specific range below the threshold.

An EVSE features a power cord with a coupler for vehicle connection, an enclosure, and internal circuitry with busbars interfacing with a power grid’s power and ground lines. The circuitry includes switches between the power cord and busbars, and a ground monitoring impedance circuit that triggers a fault if the ground line impedance exceeds a first threshold and opens the switches if it exceeds a second, higher threshold. The system is designed to exceed the second threshold if the enclosure is removed from a building’s mounting pan while busbars are energized. It also supports bidirectional energy flow between the vehicle and the power grid.

### BRIEF DESCRIPTION OF THE DRAWINGS

FIG. 1 is a schematic diagram of electric vehicle supply equipment associated with a building and a vehicle.

FIG. 2 illustrates a schematic diagram for a ground monitoring impedance circuit.

### DETAILED DESCRIPTION

Detailed embodiments of the present technology are provided herein. These embodiments, however, are intended to be illustrative rather than exhaustive, as the technology may be implemented in various alternative forms. The figures included are not necessarily to scale, with certain features exaggerated or minimized to highlight specific details of particular components. Consequently, the structural and functional details described are not to be construed as limiting but rather as a representative framework to guide those skilled in the art in applying the disclosed concepts in different ways.

Electric vehicle supply equipment (EVSE) having bidirectional energy transfer capabilities is becoming more common in the automotive industry. An EVSE with bidirectional energy transfer capabilities may allow electrical energy to flow in two directions: from a building to an electric vehicle (EV) to charge the EV, and from the EV to the building. The flow of energy from the EV to the building may occur when the building is not receiving electrical energy from a utility grid, or when the electrical energy from the grid is insufficient for the energy demands of the building. The export of electrical energy from an EV to a building is sometimes described as the EV operating in back-up mode. When an EV operates in back-up mode, the EVSE may connect the AC power output from the EV’s inverter to the building's electrical system, enabling the export of power from the EV to the building. An EVSE may also include switches to inhibit the export of electrical energy through the EVSE.

Modular EVSE designs are often used to simplify installing an EVSE. In a modular design, a mounting pan may be mounted to a building and configured to receive power supply lines of the building, including a protective earth grounding line. An EVSE may then be mounted to the mounting pan such that the EVSE is in electrical connection with the power supply and ground lines of the building. An EVSE may utilize a ground monitoring impedance circuit to measure the impedance value of the ground line to the EVSE. When an EVSE is removed from a building, the EVSE may no longer have a suitable ground line. If a vehicle is exporting power through the EVSE to the building, and the EVSE is removed from the building, the EVSE may open its switches to inhibit the continued export of power through the EVSE.

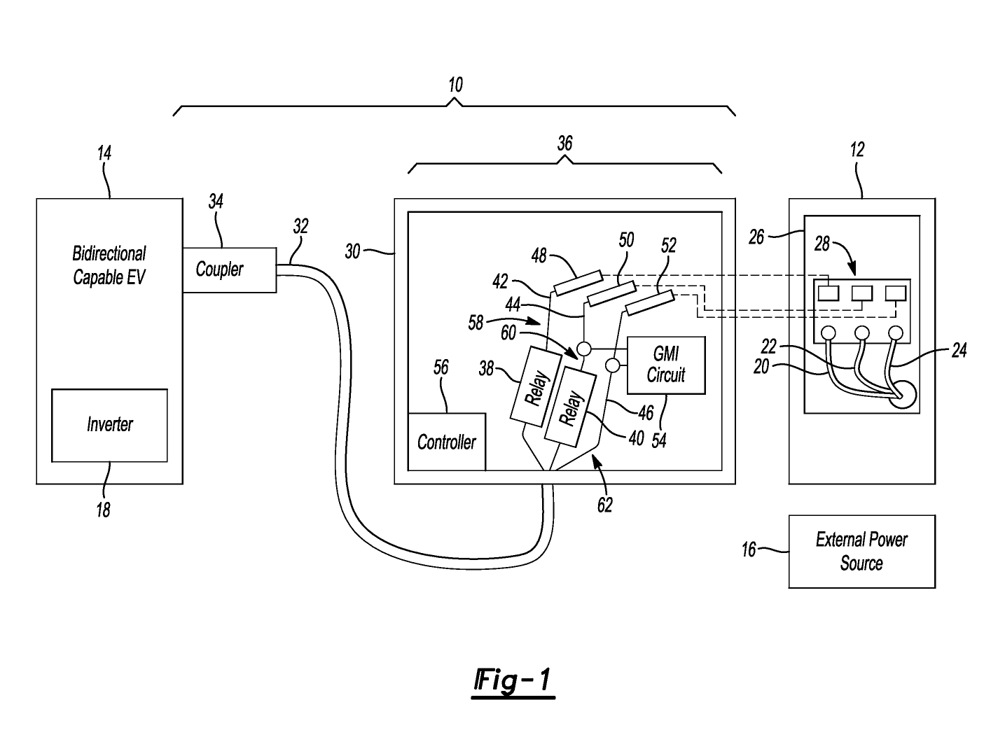

FIG. 1 depicts a diagram of electric vehicle supply equipment associated with an electric vehicle and a mounting pan. Electric vehicle supply equipment (EVSE) 10 may include circuitry, devices, and controls to enable and manage the bidirectional transfer of electrical energy between building 12 and vehicle 14. For example, EVSE 10 may facilitate the transfer of electrical energy from building 12 to vehicle 14, resulting in vehicle 14 being charged, and EVSE 10 may facilitate the transfer of electrical energy from vehicle 14 to building 12 when vehicle 14 is in back-up mode. Vehicle 14 may be an electric vehicle with bidirectional charging capabilities, including both a hybrid electric vehicle and battery electric vehicle, among others. Building 12 may be a home, a business, or other structure, connected to external power source 16. External power source 16 may be an electrical power distribution network or grid as provided by an electric utility company. Back-up mode may allow the export of electrical energy from vehicle 14 to building 12. Back-up mode may occur when building 12 is not receiving electrical energy from external power source 16 or when the electrical energy provided by external power source 16 is insufficient for the energy demands of building 12. Vehicle 14 may include inverter 18. Inverter 18 may facilitate the charging of vehicle 14 or facilitate the export of electrical energy to building 12 when vehicle 14 is in back-up mode. When vehicle 14 is in back-up mode, vehicle inverter 18 may operate in voltage control mode, maintaining a nominal output voltage, such as 240V AC, among other possible voltage levels.

Building 12 may have power lines 20, 22 that are each in electrical connection with external power source 16. Building 12 may also have ground line 24 that establishes grounding. Ground line 24 may also share a common ground with external power source 16. Power lines 20, 22, along with ground line 24, may be referred to as building wires. Mounting pan 26 may be mounted on building 12 and configured to receive building wires. Power lines 20, 22 and ground line 24 may each terminate with terminal blocks 28. For example, a first terminal block 28 and a second terminal block 28 are electrically connected to power lines 20, 22, respectively. A third terminal block 28 is electrically connected to ground line 24. Accordingly, the first and second terminal blocks 28 are electrically connected to external power source 1638 through power lines 20, 22, and the third terminal block 28 may share a common ground with building 12 and/or external power source 16 through ground line 24. Each terminal block 28 may be associated with mounting pan 26. Building 12 and building wires may have other power lines and ground lines beyond what is depicted in FIG. 1. Mounting pan 26 may receive more than two power lines from building 12, along with more than one ground line, as needed to establish an appropriate configuration to charge vehicle 14 and/or receive electrical energy from vehicle 14.

EVSE 10 may include enclosure 30 and power cord 32 extending from enclosure 30. Power cord 32 may terminate with coupler 34. Coupler 34 may be configured to be removably plugged into vehicle 14 such that power cord 32 is in electrical connection with the circuitry of vehicle 14, such as vehicle inverter 18.

EVSE 10 may also include circuitry 36. Circuitry 36 may be associated with enclosure 30, such as being disposed within enclosure 30. Circuitry 36 may include switches 38, 40, power lines 42, 44, ground line 46, busbars 48, 50, 52, ground monitoring impedance (GMI) circuit 54, and system controller 56. A power line assembly may include a switch and terminate with a busbar, with a power line electrically connecting the switch to the busbar. For example, power line assembly 58 includes switch 38 and terminates with busbar 48, with power line 42 electrically connecting switch 38 to busbar 48. Power line assembly 60 includes switch 40 and terminates with busbar 50, with power line 44 electrically connecting switch 40 to busbar 50. Similarly, a ground line assembly may include a ground line terminating with a busbar. For example, ground line assembly 62 includes ground line 46 terminating with busbar 52.

Switches 38, 40 may control the flow electrical energy between power cord 32 and busbars 48, 50. For example, switch 38 may be configured such that, when open, an electrical discontinuity exists between power cord 32 and busbar 48. Similarly, when switch 38 is closed, electrical continuity may be established between power cord 32 and busbar 48. Switch 40 may be configured such that, when open, an electrical discontinuity exists between power cord 32 and busbar 50. Similarly, when switch 40 is closed, electrical continuity may be established between power cord 32 and busbar 50. In some embodiments, switches 38, 40 may be configured as relays.

System controller 56 may be in electrical communication with GMI circuit 54. System controller 56 may also be in electrical communication with switches 38, 40 and configured to open or close switch 38 and/or switch 40. For example, system controller 56 may open or close switch 38 and/or switch 40 responsive to a command. A command may be given, for example, by a user, such as service personnel, needing to perform maintenance on EVSE 10.

GMI circuit 54 may be in electrical communication with switches 38, 40 and configured to open or close switch 38 and/or switch 40. GMI circuit 54 may cause the opening or closing of switch 38 and/or switch 40 by sending a signal to system controller 56, which then actuates switch 38 and/or switch 40 accordingly. Alternatively, GMI circuit 54 may send a signal to switch 38 and/or switch 40 causing switch 38 and/or switch 40 to actuate accordingly.

GMI circuit 54 may be in electrical connection between ground line 46 and power line 42 and/or power line 44. GMI circuit 54 may be configured to set a fault if the impedance of ground line 46 is above a first threshold value. The first threshold value may be selected and altered as required. GMI circuit 54 may be further configured to cause switches 38, 40 to open when the impedance of ground line 46 is above a second threshold value. The second threshold value may be selected and altered as required. The first threshold value by which the GMI circuit 54 sets a fault may be the same value as the second threshold value by which the GMI circuit 54 causes switches 38, 40 to open. For example, the first and second threshold value may both be 300 ohms, but other threshold values are possible. Alternatively, the second threshold value by which GMI circuit 54 causes switches 38, 40 to open may be higher than the first threshold value. For example, the second threshold value may be set as a multiple of the first threshold value, such as a value ten times higher. To illustrate, if the first threshold value is 300 ohms, the second threshold value could be 3,000 ohms. Other values of the first and second threshold values are possible and do not necessarily need to be multiples of each other. Similarly, GMI circuit 54 may be configured to clear a set fault if the impedance of ground line 46 is below the first threshold value and to close switches 38, 40 when the impedance of ground line 46 is below the second threshold value.

EVSE 10 may be configured such that when enclosure 30 is mounted to mounting pan 26, portions of circuitry 36 are in electrical connection with external power source 16 through power lines 20, 33. For example, busbars 48, 50 may each be in electrical connection with each terminal block 28 of power lines 20, 22 of building 12. Furthermore, EVSE 10 may be configured such that when enclosure 30 is mounted to mounting pan 26, portions of circuitry 36 share a common ground with external power source 16. For example, busbar 52 may be in electrical connection with terminal block 29 of ground line 24.

When enclosure 30 is mounted to mounting pan 26, EVSE 10 may facilitate the transfer of electrical energy from building 12 to vehicle 14 when vehicle 15 is coupled to coupler 34 and switches 38, 40 are closed. Switches 38, 40 may be closed as a result of GMI circuit 54 detecting a good ground. The detection of a good ground may occur when the ground impedance of ground line 46 is less than a first and/or second threshold value. When vehicle 14 is receiving electrical energy from building 12, busbars 48, 50 may be energized by external power source 16.

Furthermore, when enclosure 30 is mounted to mounting pan 26, EVSE 10 may also facilitate the transfer of electrical energy from vehicle 14 to building 12 when vehicle 14 is coupled to coupler 34, switches 38, 40 are closed, and vehicle 14 is operating in back-up mode. Switches 38, 40 may be closed as a result of GMI circuit 54 detecting a good ground. The detection of a good ground may occur when the ground impedance of ground line 46 is less than the first and/or second threshold value. When building 12 is receiving electrical energy from vehicle 14, busbars 48, 50 may be energized by vehicle 14. When building 12 is receiving energy from vehicle 14 and enclosure 30 is removed from mounting pan 26, switches 38, 40 may open, de-energizing busbars 48, 50. To explain, the removal of enclosure 30 causes the impedance of ground line 46 to exceed the first and second threshold value. When the impedance of ground line 46 exceeds the first and second threshold value, GMI circuit 54 may cause switches 38, 40 to open.

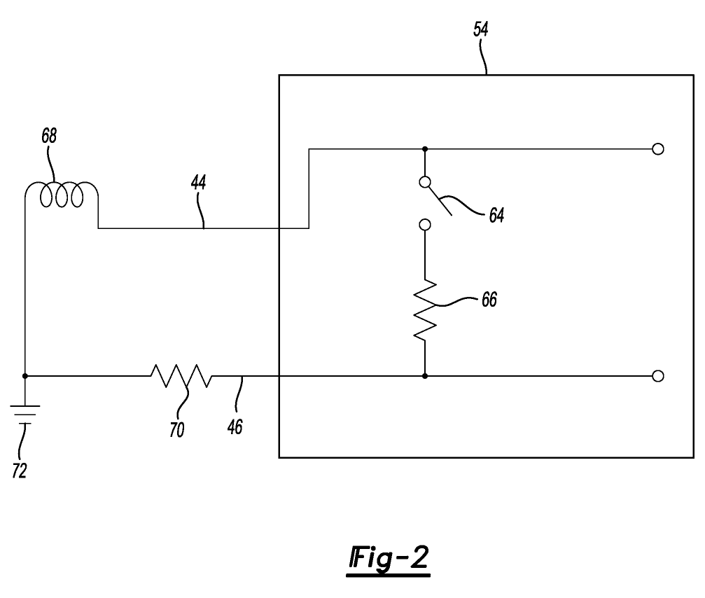

FIG. 2 illustrates an exemplary schematic for a GMI circuit. GMI circuit 54 may include switch 64 and resistor 66. GMI circuit 54 may receive energized line 44 and protective earth (PE) line 46 and monitor the voltage therebetween. In some embodiments, energized line 44 may correspond to a portion of power line 58 or power line 60 of FIG. 1. Energized line 44 may be conditioned by inductor 68. In some embodiments, inductor 68 may correspond with the circuitry of vehicle 14 of FIG. 1 when vehicle 14 is coupled to coupler 34 such that energized line 44 is energized by vehicle 14. Switch 64 and resistor 66 may be configured to electrically connect energized line 44 and PE line 46 when switch 64 is closed. Resistor 70 is indicative of the impedance of PE line 46 and is the impedance value between PE line 46 and a ground 72. GMI circuit 54 may be configured to determine the resistance value of resistor 70, indicative of the impedance of PE line 46, when switch 64 is closed. The resistance value of resistor 70 may be calculated as a function of the resistance value of resistor 66, the voltage of energized line 44 in relation to ground 72, and the voltage difference across resistor 66.

While embodiments described above illustrate various implementations, they are not intended to encompass all possible configurations or designs. The language used in this specification describes the embodiments rather than imposes limitations. Modifications and variations can be made without departing from the underlying principles and scope of the described technology. Furthermore, features from different embodiments may be combined to create additional configurations or implementations.

The algorithms, methods, and processes described herein can be delivered to or implemented by a computer, controller, or processing device, including dedicated or programmable electronic control units. These algorithms, methods, and processes may be stored as data and executable instructions in various formats, such as information permanently stored on non-writable storage media (e.g., read-only memory devices) or alterably stored on writable storage media (e.g., compact discs, random access memory, or other magnetic and optical media). They can also be implemented as software executable objects. Alternatively, these algorithms, methods, and processes may be realized partially or entirely through hardware components such as application-specific integrated circuits (ASICs), field-programmable gate arrays (FPGAs), state machines, or other suitable hardware devices. In some cases, a combination of firmware, hardware, and software components may be used to implement these functionalities.

What is claimed is:

1. Electric vehicle supply equipment comprising:
an electric vehicle supply equipment enclosure having circuitry therein including a ground line assembly and power line assemblies, the ground and power line assemblies each terminating with a busbar, the power line assemblies configured to, as a result of the electric vehicle supply equipment enclosure being removed from a mounting pan of a building while the busbars of the power line assemblies are energized by a vehicle, de-energize the busbars of the power line assemblies.

2. The electric vehicle supply equipment of claim 1, wherein the circuitry further includes a ground monitoring impedance circuit connected between the ground line assembly and one of power line assemblies.

3. The electric vehicle supply equipment of claim 2, wherein each of the power line assemblies includes a switch.

4. The electric vehicle supply equipment of claim 3, wherein the ground monitoring impedance circuit is configured to cause the switches to open as a result of the electric vehicle supply equipment enclosure being removed from the mounting pan while the busbars of the power line assemblies are energized by the vehicle.

5. The electric vehicle supply equipment of claim 4, wherein the switches are relays.

6. The electric vehicle supply equipment of claim 1, wherein the circuitry is further configured to enable bi-directional flow of energy between the vehicle and the building.

7. The electric vehicle supply equipment of claim 2, wherein the ground monitoring impedance circuit is configured to set, as a result of an impedance of the ground line assembly being greater than a first threshold but less than a second threshold, a ground monitoring impedance circuit fault.

8. Electric vehicle supply equipment comprising:
a power cord terminating with a coupler configured to be plugged into a vehicle;
an enclosure; and
circuitry disposed within the enclosure and including a plurality of busbars each configured to be electrically connected with a power line or ground line of a power grid, one or more switches electrically connected between the power cord and at least some of the busbars, and a ground monitoring impedance circuit configured to cause the one or more switches to open responsive to an impedance of the ground line being greater than a threshold.

9. The electric vehicle supply equipment of claim 8, wherein the circuitry is configured such that as a result of the enclosure being removed from a mounting pan of a building while at least some of the busbars are energized by the vehicle, the impedance will exceed the threshold.

10. The electric vehicle supply equipment of claim 8, wherein the circuitry is further configured to enable bidirectional flow of energy between the vehicle and the power grid.

11. The electric vehicle supply equipment of claim 8, wherein the ground monitoring impedance circuit sets, as a result of the impedance being less than the threshold but greater than a second threshold, a ground monitoring impedance circuit fault.

12. Electric vehicle supply equipment comprising:
a power cord terminating with a coupler configured to be plugged into a vehicle; and
circuitry disposed within an enclosure and including a plurality of busbars each configured to be electrically connected with a power line or ground line of a power grid, one or more switches electrically connected between the power cord and at least some of the busbars, and a ground monitoring impedance circuit configured to set a ground monitoring impedance circuit fault when an impedance of the ground line is greater than a first threshold and cause the one or more switches to open responsive to an impedance of the ground line being greater than a second threshold.

13. The electric vehicle supply equipment of claim 12, wherein the circuitry is configured such that as a result of the enclosure being removed from a mounting pan of a building while at least some of the busbars are energized by the vehicle, the impedance of the ground line exceeds the second threshold.

14. The electric vehicle supply equipment of claim 12, wherein the circuitry is further configured to enable bidirectional flow of energy between the vehicle and the power grid.

15. The electric vehicle supply equipment of claim 12, wherein the second threshold is at least ten times greater than the first threshold.
